(19) United States
(12) Patent Application Publication
(10) Pub. No.: US 2009/0208089 A1
(43) Pub. Date: Aug. 20, 2009

(54) METHOD FOR INSPECTING SURFACES

(75) Inventors: Christian Probst, Munchen (DE); Achim Schwarz, Taufkirchen (DE)

Correspondence Address: WOODLING, KROST AND RUST, 9213 CHILLICOTHE ROAD, KIRTLAND, OH, 44094, US

(73) Assignee: ICOS VISION SYSTEM N.V., Heverlee (DE)

(21) Appl. No.: 11/572,906

(22) PCT Filed: Aug. 5, 2004
(86) PCT No.: PCT/EP04/08757

§ 371 Date: Sep. 18, 2008

(51) Int. Cl. G06K 9/00

(52) U.S. Cl. 382/145

(57) ABSTRACT

A method for inspecting surfaces 12 with n+1 repeating patterns 16, with a camera 18 producing an image 12′ with a plurality of pixels forming a matrix of pixels, said pixels generating a technical value such as the gray value or the like, and with a computer unit 26 processing data of said pixels for the detection of the condition of said surface 12, which method comprises the following comparison steps: each value of a pixel to be inspected—inspection pixel—is compared with a value of a reference pixel, the difference of the comparison of said pixels will determined the result of the inspection. The invention is characterized in that only the values of the pixels of the matrix referring to said image 12′ are the basis for said values of said reference pixels to detect the condition of said surface 12.

The present invention relates to a method for inspecting surfaces according to the features of the preamble of claim 1 and to a device for performing the method according to the features of claim 21.

Known from the state of the art is a method and a device for inspecting surfaces with repeating patterns. The corresponding surface is usually a conductor board having conductors on it. The conductors form repeating patterns which are arranged between surfaces having no patterns and thus no conductors or unique (non-repeating) patterns. The present invention concerns only those areas where there are repeating patterns; areas with unique pattern are inspected by previously known, state-of-the-art methods. The device for inspecting surfaces comprises a camera having a CCD/CMOS camera sensor and an optical objective. The surface of the conductor board is imaged onto a CCD/CMOS camera sensor surface by means of said objective. In order to obtain a good quality of the image, the surface is illuminated by rear and/or front lights. The analog or digitized image of the camera sensor is transmitted to a computing unit. Said image is transformed by a plurality of pixels forming a matrix of pixels. Said computer unit processes data of said pixel matrix, with each pixel having a technical value.

Normally the pixel data basically used is the gray value. Each pixel generates a gray value corresponding to a color of the original of the image, namely the conductor board, in the same position relative to the original. The gray value constitutes the basic data for the detection of the condition of a surface as this value will be compared with values of reference pixels by the computer unit according to the following comparison steps : each value of a pixel to be inspected—inspection pixel—is compared with a value of a reference pixel of a so called master image. The master image is e.g. based on an image of an original conductor board which has already been inspected in detail, with the result that this master conductor board has no defects, is in good condition and qualifies use as a reference conductor board.

In the comparison step, each pixel of the image of the conductor board to be inspected will be compared with the corresponding pixel—reference pixel—of the image of the master conductor. The difference resulting from the comparison of the inspection pixel and the reference pixel will determine the result of the inspection. On the basis of the intensity of the gray value of each pixel of an image, said image could be detected very accurately.

In the field of image processing it is important to detect the defects of conductors which appear at the surface very fast, as the known devices for inspecting surfaces are often arranged in the conductor board manufacturing line. Moreover, in order to ensure constant quality of the conductor boards, it is necessary to inspect the surface of each conductor board. However, the known methods are very complex and time-consuming, as the abovementioned master image forms the basis of the comparison steps with values of the inspection pixels and values of the reference pixels of the master image—conventional teach in method. The data volume required to store the master image is very high. The storing of data is thus time-consuming and requires a lot of memory space in the computer unit. Furthermore, it should be noted that no conductor board of a manufacturing line will ever be 100% identical with any other conductor board of this line. Consequently, with the known teach in based methods, minor deficiencies of the master mainly tend to increase the pseudo-defect rate. Thus, a lot of conductor boards are categorized as defect although they are in good condition and exhibit no surface defects but merely a minor tolerance with respect to the master image.

It is therefore an object of this invention to provide a method and a device for inspecting surfaces according to the features of the preamble of claim 1 as well as a device according to the features of claim 21 in order to overcome the above noted disadvantages, to provide the prerequisites for accelerating the surface inspection process and to make the method of inspection more accurate, especially with respect to the defect rate.

These as well as other objects of the present invention are accomplished generally through the method for inspecting surfaces according to the features of the preamble of claim 1 in which only the values of the pixels of the matrix referring to said image are the basis for said values of said reference pixels for detecting the condition of said surface. Therefore, the determination of a master and the generation of a master image will no longer be necessary. Owing to the cited measures and the method according to the invention the method becomes faster and simpler over the teach-in method.

In a preferred embodiment of the invention, the values of the inspection pixels of the one pattern are compared with the values of the pixels of another pattern from the same image, and thus from the same matrix. The other pattern is used as a reference pattern having said reference pixels. Each inspection pixel and the corresponding reference pixel have the same position relative to its pattern. This will guarantee that only the values of the same kind of pixel are compared in order to obtain a significant result. However, any pixel of the same kind of patterns can also be used.

According to a further embodiment of the invention, several comparison steps are provided along a line of pixels having n+1 periodic structures as part of said repeating patterns in a direction of said line of pixels, with all of said comparison steps along said line of pixels forming a detection step. This is done for all pixels of the periodically repeating pattern. Thus, the matrix of pixels will be detected systematically line by line until the whole matrix has been detected.

If the original, and thus the image, does not exhibit a continuous regular pattern over its whole range, it is advantageous to determine an area of the matrix of the image of the surface to be inspected before inspection starts, with said area occupying either part of the matrix or the entire matrix. This way it is possible to detect area by area in optimized comparison steps according to optimized lines with respect to the patterns.

In yet another embodiment, several detection steps are provided, and after the execution of all of said detection steps all values of all the pixels of said area will have been detected. Especially, each detection step includes n comparison steps.

Due to the fact that the area of the image to be inspected comprises regular repeating patterns at least in the determined area mentioned above, it is considered advantageous to use vector calculation in said comparison step where said inspection pixel and the assigned reference pixel have a relative location within said matrix and thus a location relative to each other forming a vector k. Said vector k is the same in each comparison step. In a simple way multiple comparison steps can thus be executed with the aid of vector calculation using vector k to accelerate the inspection process.

According to another embodiment of the invention, the reference pixel is the pixel inspected in the previous comparison step.

The method of the invention allows the value of the reference pixels to be obtained in different ways with the value being based on pixels of the matrix of the image to be inspected.

One preferred way of obtaining the value of the reference pixel is by making the value of the reference pixel a calculated value based on several pixels of the matrix. This value could for instance be an average of several values of reference pixels of the matrix, or an average of values which do not exceed a threshold, and the like. This step allows the inspection of pixels at the border of the matrix or within the determined area in a simple manner.

Especially, the value of the reference pixel is calculated by an integer multiple of vector k.

According to a further embodiment of the invention, the detection of the condition of said surface includes a decision step: Decision, on the basis of said difference resulting from the comparison step, that the inspected surface is correct if the difference does not exceed at least a threshold. Particularly, the decision step will qualify the dedicated vector k and thus the dedicated pattern as defect if said difference exceeds said threshold. If the difference does exceed said threshold, the detection step is repeated in a diametrical direction which results in another vector k′ (k′=−k). This allows the detection of the inspection pixel—and thus of the real position of the inspection pixel—which exceeds said threshold by calculation on the basis of the data of both detection steps with vector k and vector k′. For instance, in the detection step with vector k and in the detection step with vector k′ different inspection pixels will be categorized as defect due to the so called shadow effect explained in detail in the description of the Figures below. A calculation scheme which is based on the location of these two pixels will allow the actual defect pixel to be determined.

Using the principle of the method of the invention, it is possible to detect defects in a regular pattern without knowing any master pattern. This will result in a drastic data reduction compared to the conventional teach in method.

In practice, the input device often limits the inspected area, e.g. the camera lens coverage. If the repeating pattern stretches wider than the inspected area, accurate positioning is not critical as long as vector k remains valid.

If vector k is small, slow distortions in the pattern that add up over large distances will not produce strong defect signals, unlike conventional teach in methods. This helps, for instance, when dealing with lens distortion or warped and strained products.

There are different possible ways of determining vector k. According to one preferred embodiment, vector k is determined by a fast Fourier transform—FFT—such that the maximum of the fast Fourier transform will found at vector k.

Alternatively, vector k is calculated e.g. with the help of a Hough transform, or vector k is calculated from data of a predetermined, especially digital, drawing of the original surface.

It should be understood that the direction of the line in the detection steps or the direction of vector k is dependent on the kind of patterns.

As mentioned, there are several ways of obtaining vector k. These ways are summarized as follows:
Often there is a technical drawing or a database where the user can look up the direction and the distance of two pattern instances.
In a digitalized camera image the user can try to set up a profile and an estimated vector k.
The signal data can be transformed using a fast Fourier transform, e.g. using a discrete 2D-FFT in case of a digital gray value image. A peak in the frequency space can be used to extract vector k. The method works well if the reference pattern is determined by a dominant frequency. If there are several peaks (except harmonics) for line-like patterns they indicate the presence different directions and distances. They can be combined to form a common vector k.
If some assumptions can be made about the pattern, e.g. parallel lines in a digitalized camera image, a Hough transform can be applied to obtain a description of the pattern that will allow obtaining the vector k automatically.
The software can simply test all the directions and lengths—using a certain small step size—and take a vector k that will yield the lowest overall defect intensity. This vector can be refined using an even smaller step size.

According to yet another embodiment of the invention, said value is the gray value (GV) of a pixel and the surface to be inspected could be the surface of a conductor board and the patterns could be conductors of the conductor board.

The above mentioned as well as additional objects of the present invention are accomplished generally by the device according to the features of claim 21 where said device is able to perform said method according to any one of the preceding claims by means of a camera producing an image with a plurality of pixels forming a matrix of pixels and a computer unit processing data of said pixels for the detection of the condition of said surface.

Further advantages and possible applications of the present invention will be apparent from the following detailed description in which reference is made to the exemplifying embodiments illustrated by way of example in the drawings.

In the description, the claims, the abstract and the drawings, use is made of the terms and corresponding reference numerals summarized in the list provided at the end of the description. In the drawings:

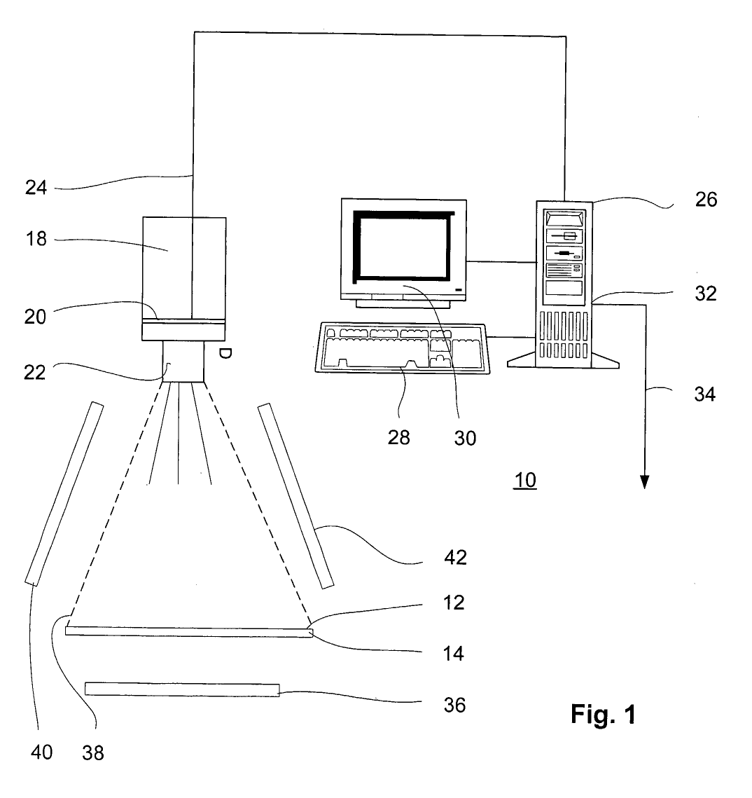

FIG. 1 is a schematic view of the device according to the invention;

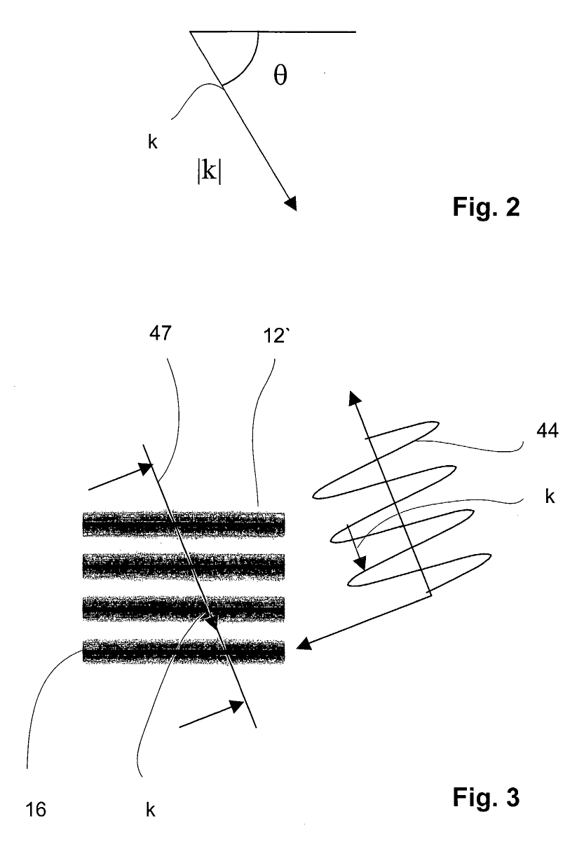

FIG. 2 is a schematic view of vector k used in a calculation step according to the invention;

FIG. 3 is a schematic top view of an image of a pattern to be inspected showing a corresponding sine curve with respect to the gray value of the pixels along a line according to a first embodiment of a pattern showing corresponding vector k;

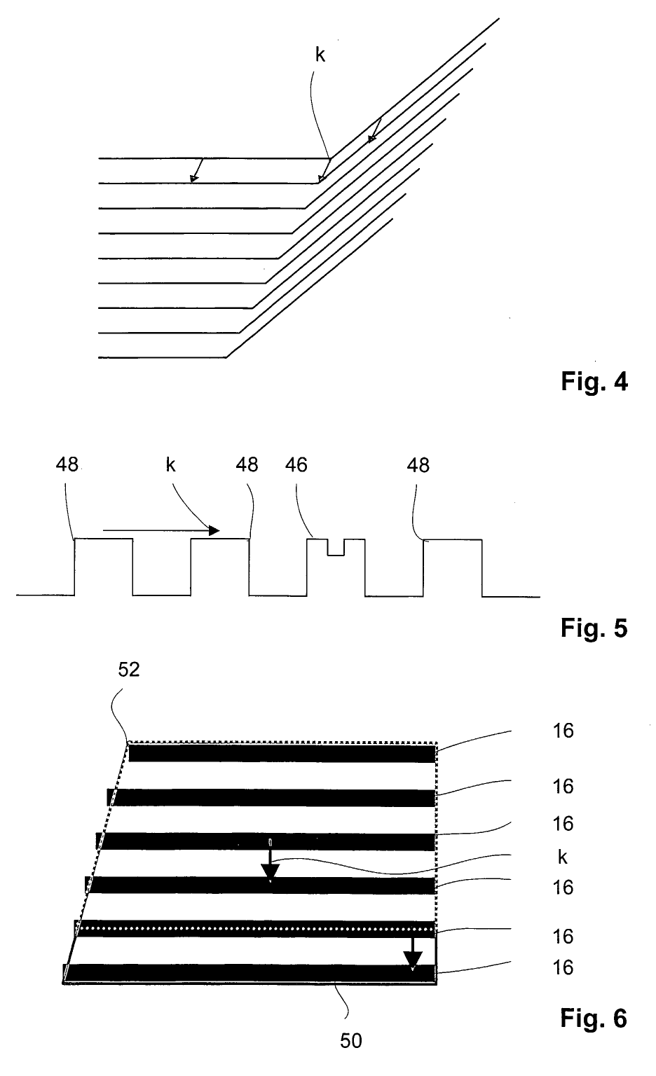

FIG. 4 is a schematic top view of an image of a pattern to be inspected according to a second embodiment of a pattern showing the corresponding vector k;

FIG. 5 is a diagram of the intensity of the gray value of the pixels to be inspected along a line corresponding to the direction of vector k according to a third embodiment of a pattern showing the corresponding vector k;

FIG. 6 is a schematic top view of an image of a pattern to be inspected according to a fourth embodiment of a pattern showing the corresponding vector k and a determined area to be inspected;

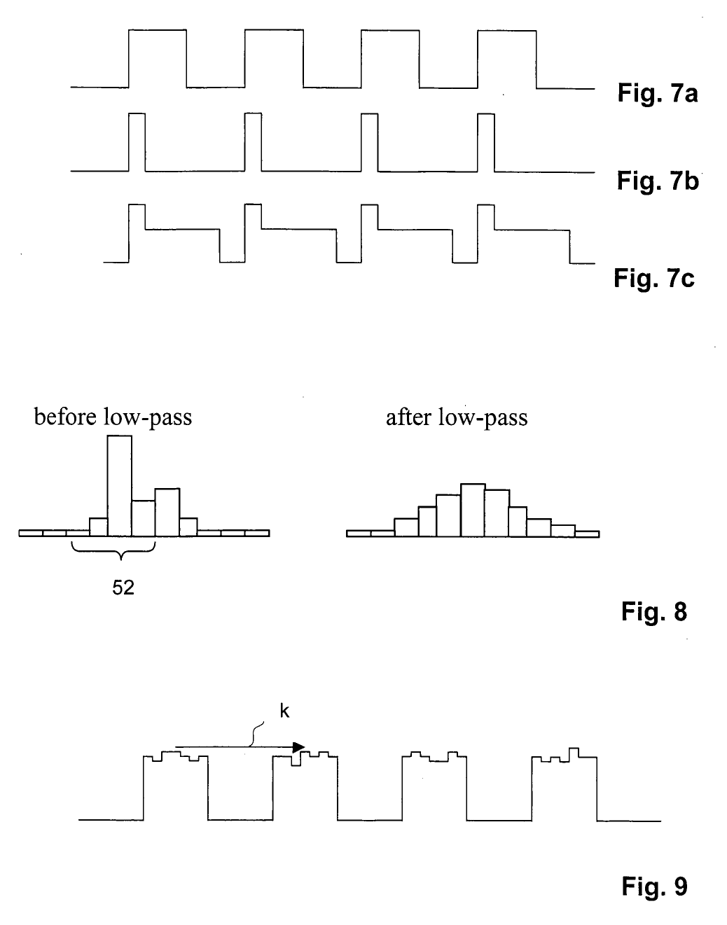

FIG. 7a is a diagram of the intensity of the gray value of the pixels to be inspected along a line corresponding to the direction of vector k according to the fourth embodiment of a pattern;

FIG. 7b is a diagram of the intensity of the gray value of the pixels to be inspected along a line corresponding to the direction of vector k according to a fifth embodiment of a pattern;

FIG. 7c is a diagram of the intensity of the gray value of the pixels to be inspected along a line corresponding to the direction of vector k according to a sixth embodiment of a pattern;

FIG. 8 are two diagrams of the intensity of the gray value of the pixels to be inspected without and with a low-pass filter, respectively;

FIG. 9 is a diagram of the intensity of the gray value of the pixels to be inspected having an non-homogenous surface with respect to the conductor along a line corresponding to the direction of vector k according to a seventh embodiment of a pattern;

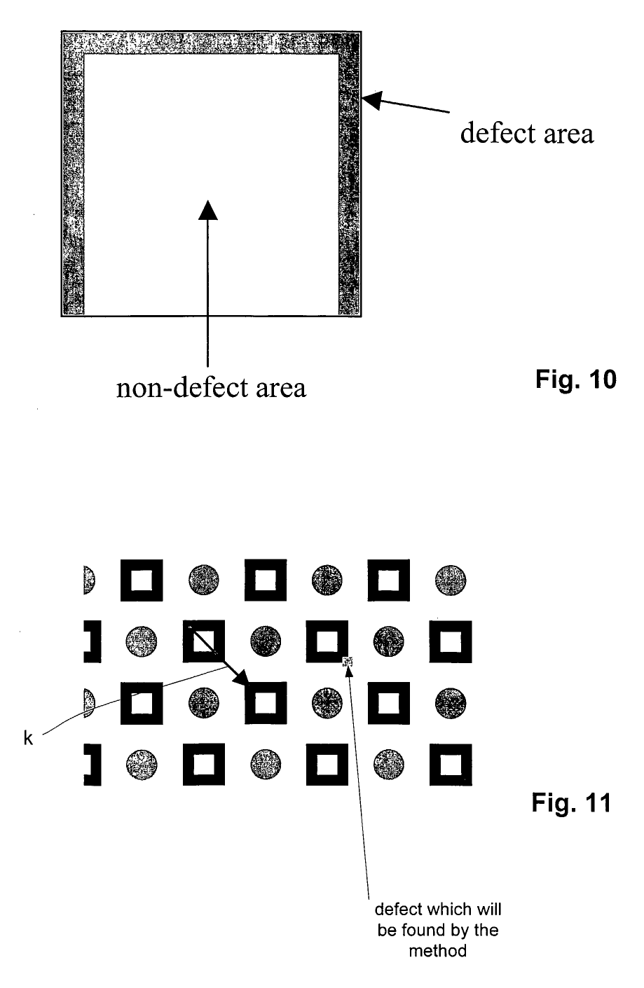

FIG. 10 is a schematic top view of an inspection area of a pattern to be inspected according to an eighth embodiment of a pattern showing the corresponding vector k;

FIG. 11 is a schematic top view of an image of a pattern to be inspected according to a ninth embodiment of a pattern showing the corresponding vector k;

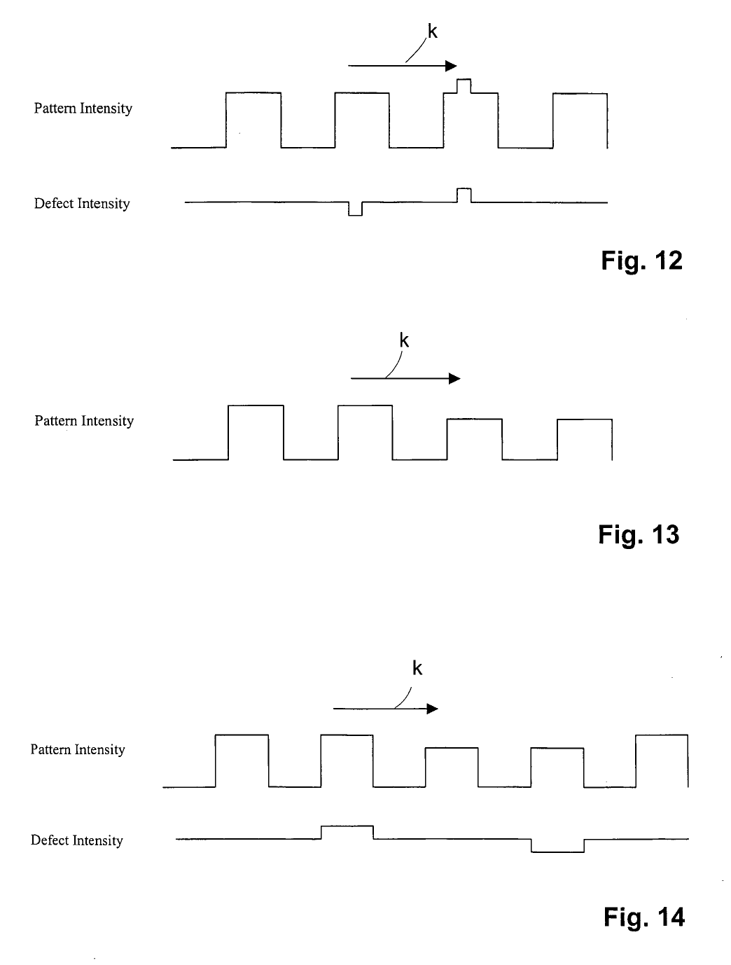

FIG. 12 is a diagram of the intensity of the gray value of the pixels to be inspected along a line and a further diagram of the intensity of the defect according to a tenth embodiment of a pattern;

FIG. 13 is a diagram of the intensity of the gray value of the pixels to be inspected along a line according to an eleventh embodiment of a pattern;

FIG. 14 is a diagram of the intensity of the gray value of the pixels to be inspected along a line and a further diagram of the intensity of the defect according to a further embodiment of a pattern;

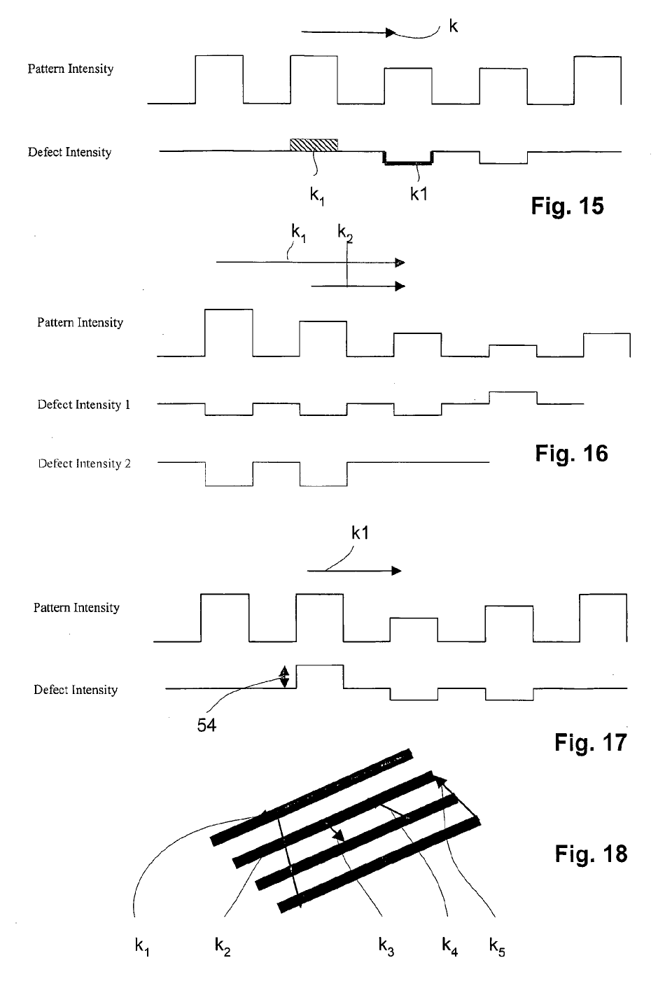

FIG. 15 a view of the diagram of FIG. 14 showing vector k and a shadow effect;

FIG. 16 is a diagram of the intensity of the gray value of the pixels to be inspected along a line and two further diagrams of the intensity of the defect according to a further embodiment of a pattern showing vector k₁ and vector k₂;

FIG. 17 is a diagram of the intensity of the gray value of the pixels to be inspected along a line and a further diagram of the intensity of the defect according to a further embodiment of a pattern showing vector k and a threshold, and

FIG. 18 is a schematic top view of an image of a pattern to be inspected according to FIG. 6 showing several possible vectors k₁ to k₄ and an impossible vector k₅.

FIG. 1 shows a schematic view of a device 10 for inspecting surfaces 12 of a conductor board 14 with repeating patterns formed by conductors 16 of the conductor board 14. The conductors 16, especially shown in FIG. 6, are arranged on the conductor board 14 between surfaces having no patterns and thus no conductors 16. The conductor board 14 is of a base material 14a which is transparent, whereas the conductors 16 themselves are nontransparent.

The device 10 comprises a camera 18 having a CCD camera sensor 20 and an optical objective 22. Via line 24, the CCD camera sensor 20 is connected to a computer unit 26 having a keyboard 28 for adjusting the parameters of the inspection method and a display 30 for displaying the inspection results and the actual method steps. The computer unit 24 comprises a port 32 which could be connected—via a line 34—to a handling machine—not shown—eliminating defect conductor boards 14. Provided underneath the conductor board 14 is a rear light 36, and above as well as outside of a maximal detection cone 38 of the camera 18 front lights 40 and 42 are arranged.

For inspection of the surface 12 of the conductor board 14, the surface is imaged onto the surface of the CCD camera sensor 20 by means of the optical objective 22. In order to obtain a good quality of the image, the surface 12 is illuminated by the rear 36 or front lights 40 and 42.

The digitized image of the CCD camera sensor 20 is transmitted to the computing unit 26 via line 24. Said image is formed by a plurality of pixels forming a matrix of pixels. Said computer unit 26 processes data of said matrix of pixels each having a technical value, namely an assigned gray value.

The gray value constitutes the basic data for the detection of the condition of a surface 12 as this value is compared with values of reference pixels by the computer unit 26. The steps of the method according to the invention are as follows:
Determination of an area of the matrix of the image 12′ of the surface 12 to be inspected, where said area is part of the matrix or the whole matrix.
Each value of a pixel of the conductor 16 to be inspected—inspection pixel—is compared with a value of a reference pixel of another conductor 16 from the same image and thus from the same matrix. The other conductor 16 is used as a reference conductor 16 having said reference pixels. Each inspection pixel and the corresponding reference pixel have the same position relative to their conductor 16; the difference of the comparison of said pixels will determine the result of the inspection—comparison step.
Several comparison steps along a line of pixels having n+1 periodic structures as part of the repeating patterns of the conductors 16 in a direction of said line of pixels are provided, in which all of said comparison steps along said line of pixels form a detection step.
Several detection steps are provided and after execution of all of said detection steps all values of the pixels of the area will have been detected. Especially, each detection step includes n comparison steps.
The reference pixel is the pixel inspected in the previous comparison step.

Due to the fact that the area of the image to be inspected comprises regular repeating conductors 16 in the determined area mentioned above in the comparison step, vector calculation is used where the inspection pixel and the assigned reference pixel have a relative location within said matrix and thus a location relative to each other forming a vector k. Vector k is the same in each comparison step. In other words: Vector k represents a period of the structure formed by the conductors 16 in the line mentioned above.

If the end position of vector k does not necessarily point to a pixel, the gray value at the end position is determined by interpolating the gray value of neighboring pixels.

Generally, the reference pixels can be interpolated using their neighborhood. Methods for obtaining the reference pixels are for instance:
Four-pixel neighborhood: Calculate the area in which a non-aligned pixel covers an aligned pixel and use the area percentage as the share to sum up the pixel intensity over the neighborhood.
Three-pixel neighborhood: Interpolate using the intensities of the three closest neighbors according to their proximity to the non-aligned pixel center.
Distribution method: Use distribution, e.g. Gaussian curve, to obtain weights for the intensity of a certain neighborhood pixel.

Typically the interpolation is imperfect. One way to reduce the defect intensity caused by interpolation is using a low-pass filter, Gaussian filter, as described in connection with FIG. 8.

Depending on the low-pass filter and its size, it can also be used to attenuate small spatial defects.

According to FIG. 2 vector k has a norm, |k| now given in pixels, and an orientation, angle θ in degrees, positive in clockwise direction. Vector k has 1, 2, . . . , n periods in an area with n+1 patterns of conductors 16. Angle θ allows the inspection of periodic structures along the line mentioned above that can also be other than horizontal or vertical.

FIG. 3 is a schematic top view of an image 12′ of the surface 12 of the conductor board 14 with a sine curve 44 with respect to the gray value of the pixels along a line 47 according to a first embodiment of a pattern of the conductor board 14. According to this embodiment, vector k is periodic in any direction of the image 12′ of the surface 12 of the conductor board 14.

FIG. 4 shows a second embodiment of a pattern of the conductor board 14. For the inspection of transition regions between two different gratings, e. g. different angle, different period, there is the common period vector k. This vector k can be seen through the intersection of both conductors 16 in the transition region.

FIG. 5 shows an example of a gray value profile of several comparison steps with a defect at the third peak 46. This defect does not occur at its neighboring peaks 48. Peak 46 could be detected with help of vector k comparing the gray value of the inspection pixel with the gray value of the reference pixel previously inspected.

A pattern typically has a fixed border. If the algorithm using vector k checks the complete pattern, it will yield a defect at the border because the vector k points outside the pattern area.

It is useful to reduce the inspection area in a way that vector k does not point outside the pattern. If there is a defect, at the last instance of the pattern in vector k direction, the defect can be replicated and compared to a master value as described below in connection with FIG. 12 and FIG. 13.

FIG. 6 shows an example of how to determine the inspection area. The inspection area is a polygon having the reference number 50. An algorithm shrinks the area 50 on the basis of vector k to the area with reference number 52, otherwise the last conductor 16 would be compared to an area outside the determined inspection area 50.

The adjusted polygon should be convex because the software takes only the leftmost and the rightmost border of a polygon as a boundary for each line.

As mentioned above, vector k defines the distance between two neighboring conductors 16 forming a repeating pattern of the conductor board 14. The distance and angular direction can be set directly.

It is also possible to use a fast Fourier transform—FFT—to determine vector k automatically. FIGS. 7a, 7b and 7c show a diagram of the intensity of the gray value of the pixels to be inspected along a line corresponding to the direction of vector k according to the fourth and fifth embodiment of a pattern of the conductor board 14.

When selecting the automatic calculation function, the user is asked to adjust a box above the pattern. It is not necessary to include the whole inspection area. As a rule of thumb, at least 10 instances of the pattern should be included. However, a big box may take some time to complete.

If the gray-value difference between two pixels exceeds a certain value, the pixel position will be considered to be defective. If the gray-value difference is smaller, the difference will be considered to be noise, i.e. negligible. This value is called surface noise level.

To remove the impact of local gray value changes, the user may use a low-pass filter. It averages the values over a certain distance, the so called low-pass length 52, as FIG. 8 illustrates.

An example to illustrate the effects of a four-pixel low-pass filter—1-dimensional—is shown in FIG. 8. Using a low-pass filter will typically reduce the sensitivity to camera noise and small surface irregularities. A value of four or above is recommended for most applications.

In many cases, a pattern of the conductor board 14 consists of a homogenous background—the transparent base material 14a—and a non-homogenous foreground—conductor 16—as shown in FIG. 9. This phenomenon is based on the fact that bright areas on the surface of a conductor board have a bigger variation.

To reduce the impact of this foreground variations, the user can set a white pixel attenuating percentage. For instance, if the percentage is set to 30%, the gray-value difference that is used to find defects will be reduced by 30%, if the pixel has the maximum gray value of 255. If the pixel in question only has a gray value of 128—half of the maximum, the gray-value difference will only be reduced by 15%.

Polygonal special regions can be created to exclude certain parts of an area 50. Inside these special regions, all defect pixels will be ignored. The polygonal special region should be convex because the software takes only the leftmost and the rightmost border of a polygon as a boundary for each line. Split up the regions if necessary.

It is possible to create special regions automatically by selecting a ‘Teach In’ option. However, care must be taken that a proper image is obtained showing a good device. It is therefore recommended to check the created special regions with the special regions menu entry afterwards. Especially, if the defect areas look as shown in FIG. 10, the smallest convex polygon will cover the whole inspection area. In this case, it is advisable to set the special regions manually.

The method according to the invention can be extended into more dimensions, e.g. repeating two-dimensional patterns as shown in FIGS. 6 and 11. To the human observer the defects are obvious. It should clearly be noted that the dimensions need not be spatial.

FIG. 11 shows a further simple two-dimensional repeating pattern.

If I_{act} is the actual intensity of the pixel of the image to be inspected and I_{comp} is the intensity of the reference pixel used for comparison, a defect intensity can be defined as:

I_{d}=I_{comp}−I_{act}

However, there may be other definitions with several side conditions, e.g. enforced minimum intensity, etc. If the defect intensity exceeds a certain application dependent threshold, a pattern can be judged as defective.

When checking a pattern using the described algorithm based on vector k, the absolute of the defect intensity will be high at the place where the defect is located, but also at the corresponding comparison location. FIG. 12 illustrates this situation.

However, it is often interesting to know where the actual defect is and what sign its intensity has.

If more instances of the pattern are available, it is possible to use some or all of them to get an idea about the ‘correct’ intensity, called the master intensity. Methods to accomplish this are for instance:
Mean value over the instances used. Unfortunately, the intensity of the defect pixel will affect the master intensity.
Outlier removal: A certain number of intensities are removed from the mean calculation, e.g. if they differ too much from the average or they are among the n most differing intensities.
Median value
Majority vote: Take either I_{act} or I_{comp} as master intensity depending on what is closer to the average value of the instances.

If the intensity I_{act} or I_{comp} is close to the master intensity, one of them can be neglected as defect shadow.

Sometimes it still cannot be decided what the master intensity is, as shown in FIG. 13. In practice there is only a limited number of instances and if their intensities happen to cluster into two groups of the same size, the master intensity cannot be obtained without imposing side conditions.

The effort to perform this check is a minor one, as only areas with defects or defect shadows are checked and defects are rare.

The algorithm using vector k finds defects only at their edges, if they are longer than vector k as illustrated in FIG. 14. If it is necessary to get the correct defect intensity and position, the defect needs to be replicated into the defect candidate and then checked against the master intensity, if available. According to FIG. 15 the original defect intensity was changed to reflect the true size of the defect.

The effort required to perform this check is small if only areas with defects or defect shadows are checked and defects are rare.

Because the algorithm using vector k₁ detects local changes, slowly changing patterns may not yield a significant defect intensity. Taking a different vector k₂ can alleviate this situation. It is even possible to use more than one vector k₁, k₂ . . . , kₘ simultaneously and take the maximum defect intensity, as shown in FIG. 16.

A variant of the occurring problem is illustrated in FIG. 17. The defect intensity at the second instance of the pattern exceeds the defect threshold, while the defect intensity at the third instance is quite small and does not exceed the defect intensity threshold 54.

If it is not desired to check several vectors k₁, k₂ kₘ, e. g. to save computation time, the defect shadow at the second pattern instance must not be removed as mentioned above though the pattern intensity matches the master intensity. Otherwise no defect will be triggered at all. According to FIG. 17 the defect shadow has a stronger defect intensity than the real defect.

Vector k is a property of the pattern. Obtaining the correct vector k is necessary in order to obtain good results. As FIG. 18 shows, there is usually no single optimal vector k. Several vectors k for this pattern are valid.

The pattern usually has a border that can be defined by the user.

It is possible, however, to automatically determine a coherent region, i.e. a region containing a pattern that can be inspected using a single vector k.

One way is to start with some arbitrary initial regions and split them until they are coherent as mentioned above.

If two adjacent regions can be inspected with the same vector k, they will be merged. Several varieties of this well-known split-and-merge algorithm are available.

If a region is singular, i.e. there is no repeating pattern, hence no vector k to inspect it, the region can be inspected using a completely different method (teach in comparison, etc.). If the pattern repeats itself in time, which is typically true during the optical inspection of some device, one instance of the singular pattern can be compared with its successor, e.g. the next part under the camera.

### LIST OF REFERENCE NUMERALS

10 device for inspecting surfaces

12 surface

12′ image

14 conductor board

14a base material of the conductor board

16 conductor

18 camera

20 CCD camera sensor

22 optical objective

24 line

26 computer unit

28 keyboard

30 display

32 port

34 line

36 rear light

38 detection cone

40 front light—left

42 front light—right

44 sine curve

46 peak

47 line

48 neighboring peaks

50 inspection area

52 low-pass length

54 threshold

1-13. (canceled)

14-21. (canceled)

22. A method for inspecting surfaces, said surface (12) includes n+1 repeating patterns (16), a computer unit (26), a camera (18), said camera produces an image (12′) with a plurality of pixels forming a matrix of pixels, said pixels generating a technical value such as a gray value, and said computer unit (26) processes data of said pixels for the detection of the condition of said surface (12), said method comprises the steps of:
analyzing the repeating patterns (16) along a line (47) of pixels having n+1 periodic structures to determine the technical values of inspection pixels and reference pixels;
calculating, using vector calculation, a vector k with a direction (θ), wherein inspection and reference pixels have a relative location within said matrix and thus relative to each other;
inspecting each pixel to determine technical values thereof;
determining said value of said reference pixel based only on the technical values of said pixels of said matrix referring to said image (12′);
comparing said values of said inspection pixels of one of said patterns (16) with said values of said reference pixels of another pattern (16) which is used as a reference pattern (16) having said reference pixels, in which both said inspection and reference pixels have the same position relative to its pattern to detect the condition of said surface (12);
said step of comparing said pixels is repeated along a line (47) of pixels having n+1 periodic structures as part of said repeating patterns (16) in a direction of said line (47) of pixels, said step of comparing uses vector calculation where said inspection pixel and said reference pixel have a relative location within said matrix and thus relative to each other form a vector k, said vector k being the same in each comparison, said direction (θ) of said line (47) or said direction (θ) of said vector is dependent on the kind of patterns;
determining an area (50) of said matrix of said image (12′) of the surface to be inspected, said area (50) being part of said matrix or said whole matrix, at least one of said reference pixel or said inspection pixel is interpolated using its neighboring pixels, and said surface (12) to be inspected is a surface (12) of a conductor board (14) and said patterns are conductors (16) of said conductor board (14).

23. The method according to claim 22, wherein said direction (θ) of line (47) and vector k is determined by a fast Fourier transform such that the maximum of the fast Fourier transform will form said vector k.

24. The method according to claim 22 wherein said direction (θ) of line (47) and said vector k is calculated using a Hough transform.

25. The method according to claim 22 wherein the direction (θ) of line (47) and vector k are calculated from data of a predetermined, especially digital, drawing of said original surface.

26. The method according to claim 22 further comprising a detecting step and wherein all said values of all said pixels of said area (50) are detected and compared.

27. The method according to claim 22 wherein said detecting includes n steps of comparing.

28. The method according to claim 22 wherein said reference pixel is said pixel inspected in said previous step of comparing.

29. The method according to claim 22 further comprising a detecting step wherein said detection of said condition of said surface includes a comparison of the difference between the inspection pixels and the reference pixels to a threshold to determine if a defect is present.

30. The method according to claim 22, wherein the dedicated vector k and thus the dedicated pattern (16) is defective if said difference exceeds said threshold.

31. The method according to claim 30 wherein said detecting step is repeated in a diametrical direction if the threshold is exceeded, which results in another vector k′ (k′=−k).

32. The method according to claim 31, wherein said detecting step identifies the real position of said inspection pixel which exceeds said threshold by calculation on the basis of the data comparison to both vector k and vector k′.

33. The method according to claim 22 wherein said value is the gray value (GV) of said pixel.

34. A device for performing said method according to claim 22 having said camera (18) producing said image (12′) with said plurality of pixels forming said matrix of pixels and said computer unit (26) processing data of said pixels for the detection of the condition of said surface (12).

35. A method for inspecting surfaces, said surface (12) includes n+1 repeating patterns (16), a computer unit (26), a camera (18), said camera produces an image (12′) with a plurality of pixels forming a matrix of pixels, said pixels generating a technical value such as a gray value, and said computer unit (26) processes data of said pixels for the detection of the condition of said surface (12), said method comprises the steps of:
analyzing the repeating patterns (16) along a line (47) of pixels having n+1 periodic structures to determine the technical values of inspection pixels and reference pixels;
calculating, using vector calculation, a vector k with a direction (θ), wherein inspection and reference pixels have a relative location within said matrix and thus relative to each other, said vector calculation being performed by varying the direction and magnitude of vector k and thereby finding the unique direction and magnitude of vector k to yield the lowest overall defect intensity;
inspecting each pixel to determine technical values thereof;
determining said value of said reference pixel based only on the technical values of said pixels of said matrix referring to said image (12′);
comparing said values of said inspection pixels of one of said patterns (16) with said values of said reference pixels of another pattern (16) which is used as a reference pattern (16) having said reference pixels, in which both said inspection and reference pixels have the same position relative to its pattern to detect the condition of said surface (12); and,
said step of comparing said pixels is repeated along a line (47) of pixels having n+1 periodic structures as part of said repeating patterns (16) in a direction of said line (47) of pixels, said step of comparing uses vector calculation where said inspection pixel and said reference pixel have a relative location within said matrix and thus relative to each other form a vector k, said vector k being the same in each comparison, said direction (θ) of said line (47) or said direction (θ) of said vector is dependent on the kind of patterns.
